(19) United States
(12) Patent Application Publication
(10) Pub. No.: US 2016/0059346 A1
(43) Pub. Date: Mar. 3, 2016

(54) HYBRID MECHANICAL-THERMAL PROCESS FOR COATING REMOVAL

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/468,678

(22) Filed: Aug. 26, 2014

(51) Int. Cl. B23K 26/00; C23F 4/04; B23P 6/00

(52) U.S. Cl. CPC B23K 26/0051; B23P 6/002; C23F 4/04

(57) ABSTRACT

A method of removing a coating (14) from a substrate (12) by applying both vibratory mechanical energy (16, 20) and an energy beam (32) to the coating. Localized combination of thermally and mechanically induced stressed in the coating result in the formation of cracks (34) in the coating.

### FIELD OF THE INVENTION

This invention relates generally to the field of materials technology, and more particularly to the removal of coating materials from an underlying substrate.

### BACKGROUND OF THE INVENTION

Coatings are used in many applications to provide improved protection of an underlying substrate material from damage caused by environmental exposure. For example, paints are used to prevent rusting of metal or rotting of wood, and ceramic thermal barrier coatings are used to protect gas turbine engine components from the harsh combustion environment existing inside the engine. However, coatings also degrade due to environmental exposure, and they must sometimes be removed and refreshed, often accompanied by a local repair of the underlying substrate material which may have degraded as a result of a degradation of the coating.

It is known to remove coatings in a variety of ways. Abrasive procedures such as grit blasting are used to remove coatings by mechanical action. Chemicals are used to dissolve coatings. Heat is used to remove paint by burning, and intense localized heat applied by a laser energy beam is used to dislodge ceramic thermal barrier coatings by causing localized vaporization and a resulting shock wave. Coatings are designed to adhere tightly to the underlying substrate, so as the performance characteristics of coatings improve, they become ever more difficult to remove with known techniques.

### BRIEF DESCRIPTION OF THE DRAWINGS

The invention is explained in the following description in view of the drawings that show:

FIG. 1 is a schematic illustration of a component having a coated surface exhibiting a standing wave induced by vibratory mechanical stimulation of the component, and wherein coating material in a region of a trough of the wave is being heated by a laser beam.

FIG. 2 is the component of FIG. 1 after the vibratory mechanical stimulation has been controlled to move the standing wave such that the region of heated coating material now resides at a peak of the standing wave, thereby causing a fracturing the coating material in that region.

### DETAILED DESCRIPTION OF THE INVENTION

The present inventors have found that known techniques for the removal of ceramic thermal barrier coatings are becoming increasingly undesirable. Chemical methods require the handling and disposal of highly toxic compositions, and mechanical and thermal processes are often inadequate to remove the latest generations of highly adherent coatings. Laser processes can be effective, but they must be carefully controlled to achieve coating removal while avoiding substrate damage. Accordingly, the inventors have developed an improved coating removal process which synergistically combines mechanical energy with thermal energy to remove even highly adherent coatings at processing temperatures that may be lower than experienced during prior art laser removal processes.

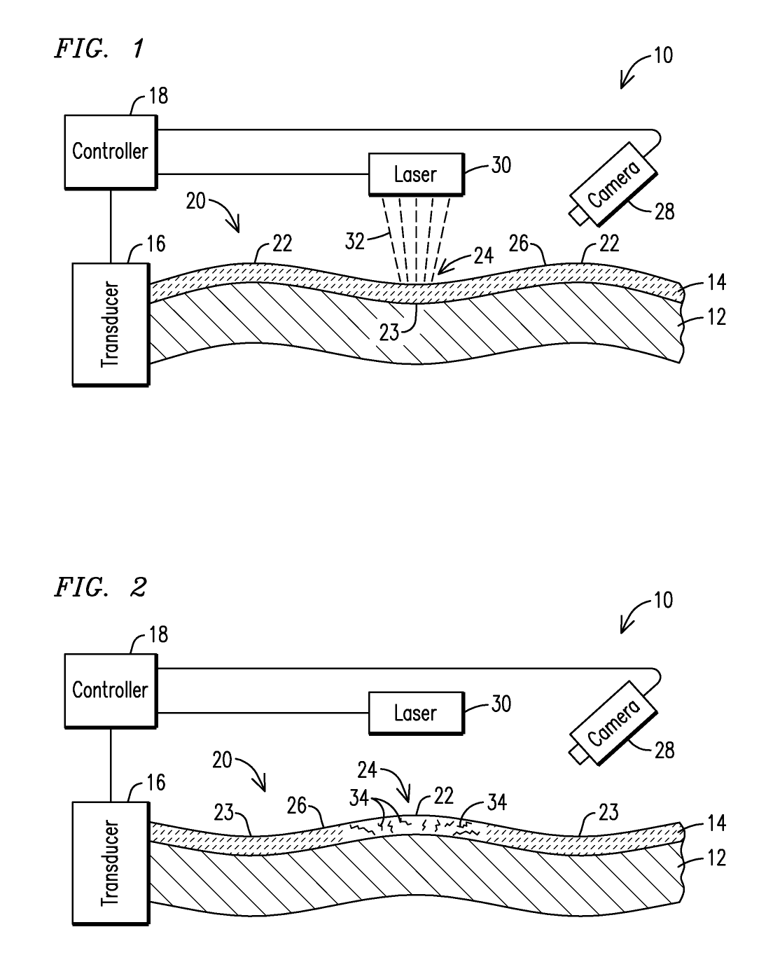

FIG. 1 illustrates a step in one embodiment of the present invention. A component 10 includes a substrate material 12 covered by a coating material 14. Of particular interest to the inventors is a gas turbine engine component formed of a superalloy substrate material coated with a thermal barrier coating including a metallic bond coat and a ceramic top coat, although one skilled in the art will recognize that the invention is not limited to such components and may be useful for the removal of a large variety of coatings from a variety of different substrate materials.

An electro-mechanical vibration transducer 16 is in contact with the component 10 and is used to impart vibratory mechanical energy into the component 10. The transducer 16 may be any known type of device which converts electrical signals into mechanical energy, such as a magnetic transducer or a piezoelectric transducer. The transducer 16 may be operated through a controller 18 to selectively control the magnitude and frequency of vibrations induced into the component 10, and in particular, to induce a wave 20 in at least the coating 14 and an underlying surface portion of the component 10. FIG. 1 exaggerates the illustration of the wave 20 to schematically show two peaks 22 and one trough 23 along the component surface 26. One skilled in the art will appreciate that peaks 22 and troughs 23 may not be visible to the naked eye in an actual embodiment, although they will generally be detectable by an instrument 28, for example an optical instrument such as a camera or laser rangefinder, or a strain gage, etc. The instrument 28 may also be connected to the controller 18 to provide feedback for controlling the transducer 16 to produce a desired form and magnitude of wave 20 in the component 10.

As illustrated in FIG. 1, a standing wave 20 may be induced into the coating 14, and a heat source, for example laser 30, may be used to heat that portion of the coating 14 in the region 24 of the trough 23 by projecting a beam of energy 32 onto the surface 26. Other sources of heat may be used, such as other forms of beam energy or a heated gas jet, for example. Both the mechanical wave action and the heating process function to impart stress into the coating 14. Heating tends to expand the coating 14 and to create differential thermal expansion stresses. The wave action generates both tensile and compressive stresses in different regions of the coating 14.

Subsequent to the step illustrated in FIG. 1, the transducer 16 is controlled to move the standing wave 20 such that a peak 22 is positioned within the region 24 that was heated, as illustrated in FIG. 2. This movement tends to further expand the coating 14 in region 24 and to generate cracks 34 in the coating 14, thereby facilitating its release and removal from the substrate 12. Some additional mechanical cleaning may be required to completely remove the fractured region 24 of the coating 14, such as light wire brushing.

Advantageously, the selective simultaneous application of vibratory mechanical energy and heat energy will create complex, complementary stress patterns in the coating 14, resulting in the overstressing and mechanical fracture of the coating 14. FIGS. 1 and 2 illustrate one embodiment where the coating 14 is subjected to relatively moving stress patterns which result in at least local transient stress conditions within the region 24 where the strength limit of the coating is exceeded, resulting in the formation of cracks 34. An alternative embodiment may include the heating of a peak region of a standing wave in a coating followed by movement of the wave such that a trough of the wave moves to the heated region of the coating. This alternative embodiment generates a different transient stress pattern in the coating than does the embodiment of FIGS. 1 and 2, but advantageously would be performed in a manner that also results in a local stress condition within the region 24 where the strength limit of the coating is exceeded, resulting in the formation of a crack 34.

In another embodiment, a transducer 16 may be controlled to move a wave 20 across the surface 26 of a coating 14, and simultaneous scanning of an energy beam 32 onto the surface 26 in a manner responsive to the movement of the wave 20, such as maintaining the beam 32 in a trough or on a peak or at any other selected location relative to the wave 20. The position of the wave 20 may be detected by any known technique, such as with a camera 28, and input to controller 18 for use in controlling the source 30 of the beam energy.

In another embodiment, a static pattern of heating may be generated on a surface 26 of a coating 14 to produce a temperature gradient pattern of relatively hot and cold regions which create differential thermal stress patterns in the coating 14. Then, a pattern of mechanical waves 20 may be swept across the surface 26 to interact with the heating pattern to fracture the coating 14 at locations where additive stresses exceed the fracture limits of the coating material.

Parameters of the laser beam 32 may be selected in response to the material of the coating 14 such that a sufficient portion of the beam's energy is absorbed by the coating 14 to raise a temperature of the coating 14 to above a temperature of the substrate 12, or at least to expand the substrate relative to the coating, to exert tensile stress on the coating. The resulting temperature differential contributes to the stress pattern generated in the coating 14. Alternatively, parameters of the laser beam 32 may be selected such that the coating 14 is largely transparent to the beam 32 so that a sufficient portion of the beam's energy is transmitted to the substrate 12 to raise a temperature of the substrate 12 to above a temperature of the coating 14. Again, the temperature difference between the substrate 12 and coating 14 will contribute to the generated stress pattern.

In an embodiment where the substrate 12 is heated to a temperature above a temperature of the coating 14, tensile force is generated in the coating 14. Vibratory mechanical energy may then be applied to the component 10, such as at a resonant frequency of the component 10, to excite the coating mechanically to a magnitude sufficient to cause fracture of the coating 14 as a result of complementary tensile stresses in the coating 14.

Methods of repairing coated components 10 may include the removal of at least a portion of the coating 14 using one of the processes described herein, repair of the underlying substrate 12 as necessary, and the re-application of coating material 14 of the same or different composition. Such methods benefit by the avoidance of the use of caustic chemicals or grit, and they have a reduced chance of damaging the component 10 as a result of the application of beam energy 32 when compared to prior art processes.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method for removing a coating from a substrate, the method comprising introducing vibratory mechanical energy into the substrate while directing an energy beam onto the coating in a manner effective to fracture the coating.

2. The method of claim 1, further comprising:
controlling the vibratory mechanical energy to form a standing wave in the substrate;
directing the energy beam into a trough of the standing wave to heat a portion of the coating; and
controlling the vibratory mechanical energy to move the standing wave such that the heated portion of the coating is on a crest of the moved standing wave.

3. The method of claim 1, further comprising:
controlling the vibratory mechanical energy to form a standing wave in the substrate;
directing the energy beam onto a crest of the standing wave to heat a portion of the coating; and
controlling the vibratory mechanical energy to move the standing wave such that the heated portion of the coating is in a valley of the moved standing wave.

4. The method of claim 1, further comprising detecting a location of a wave in the substrate created by the vibratory mechanical energy and controlling the energy beam in response to the detected location of the standing wave.

5. The method of claim 1, further comprising controlling the vibratory mechanical energy effective to induce a wave to move across the substrate.

6. The method of claim 5, further comprising controlling the energy beam responsive to a path of the wave moving across the substrate.

7. The method of claim 1, further comprising selecting parameters of the energy beam such that a sufficient portion of the beam energy is absorbed by the coating to raise a temperature of the coating to above a temperature of the substrate.

8. The method of claim 1, further comprising selecting parameters of the energy beam such that a sufficient portion of the beam energy is transmitted to the substrate effective to expand the substrate relative to the coating to exert tensile stress on the coating.

9. The method of claim 1, further comprising:
controlling the energy beam to create a temperature gradient pattern across a surface of the coating; and
controlling the vibratory mechanical energy to move a mechanical wave pattern across the surface to interact with the temperature gradient pattern in a manner effective to fracture the coating.

10. A method of repairing a coated component comprising the step of removing at least a portion of a coating from a substrate of the component in accordance with the method of claim 1.

11. A method of removing a thermal barrier coating from a gas turbine engine component, the method comprising:
inducing vibratory mechanical energy into the component in a manner effective to generate a wave in the coating;
directing a laser beam toward the coating in a manner effective to heat at least one of the coating and a substrate of the component underlying the coating; and
controlling the vibratory mechanical energy and the laser beam in a manner effective to fracture the coating.

12. The method of claim 11, further comprising:
inducing a wave in the coating with the vibratory mechanical energy;
heating a portion of the coating in a trough of the wave with the laser beam; and
moving the wave in the coating such that the heated portion of the coating is located on a crest of the standing wave.

13. The method of claim 11, further comprising:
inducing a wave in the coating with the vibratory mechanical energy;
heating a portion of the coating on a crest of the wave with the laser beam; and
moving the wave in the coating such that the heated portion of the coating is located in a trough of the standing wave.

14. The method of claim 11, further comprising detecting a location of the wave in the coating and controlling the laser beam in response to the detected location.

15. The method of claim 11, further comprising controlling the vibratory mechanical energy effective to induce the wave to move along a surface of the coating.

16. The method of claim 15, further comprising controlling the laser beam responsive to a path of the wave moving across the surface.

17. The method of claim 11, further comprising selecting parameters of the laser beam such that a sufficient portion of the beam's energy is absorbed by the coating to raise a temperature of the coating to above a temperature of the substrate.

18. The method of claim 11, further comprising selecting parameters of the laser beam such that a sufficient portion of the beam's energy is transmitted to the substrate effective to expand the substrate relative to the coating to exert tensile stress on the coating.

19. The method of claim 11, further comprising:
controlling the laser beam to create a temperature gradient pattern across a surface of the coating; and
controlling the vibratory mechanical energy to move a wave pattern across the surface to interact with the temperature gradient pattern in a manner effective to fracture the coating.

20. A method of removing a coating from a substrate, the method comprising:
generating a first pattern of stress in a region of the coating by applying a vibratory mechanical energy to the coating;
generating a second pattern of stress in the region of the coating by applying an energy beam to create heat;
creating relative motion between the first and second patterns of stress effective to create a local transient stress condition within the region where a strength limit of the coating is exceeded, resulting in the formation of cracks.
